(19) United States
(12) Patent Application Publication
(10) Pub. No.: US 2011/0053499 A1
(43) Pub. Date: Mar. 3, 2011

(54) WIRELESS COMMUNICATION DEVICE

(75) Inventor: TZU-CHENG YU, Shindian (TW)

(73) Assignee: FIH (HONG KONG) LIMITED, Kowloon (HK)

(21) Appl. No.: 12/702,374

(22) Filed: Feb. 9, 2010

(30) Foreign Application Priority Data
Aug. 27, 2009 (CN) 200910306147.2

(51) Int. Cl. H04B 7/00; H04B 5/00

(52) U.S. Cl. 455/41.1; 455/41.3

(57) ABSTRACT

A wireless communication device includes a main terminal for communicating with other conventional wireless communication devices through wireless communication systems, and at least one subsidiary terminal communicating with the main terminal using short distance wireless communication signals. Audio signals, messages and instruction input into the subsidiary terminal are sent to the main terminal by the subsidiary terminal and sent to other wireless communication devices by the main terminal. Wireless signals corresponding to audio signals and/or messages received from other wireless communication devices by the main terminal are sent to the subsidiary terminal to be played and/or displayed.

### BACKGROUND

1. Technical Field

The present disclosure relates to wireless communication devices, and particularly to a wireless communication device having simplified terminals.

2. Description of Related Art

Wireless communication devices, such as mobile phones, personal digital assistants (PDA), and laptop computers, are widely used. Nowadays, most wireless communication devices have become multifunctional. For example, many wireless communication devices can also be used to capture images or play games. However, multifunctional wireless communication devices need more hardware and software installed to perform the additional functions, which makes miniaturization difficult. Thus, multifunctional wireless communication devices having more simplified structures and/or less size are desired.

Therefore, there is room for improvement within the art.

### BRIEF DESCRIPTION OF THE DRAWINGS

Many aspects of the present wireless communication device can be better understood with reference to the following drawings. The components in the various drawings are not necessarily drawn to scale, the emphasis instead being placed upon clearly illustrating the principles of the present wireless communication device. Moreover, in the drawings, like reference numerals designate corresponding parts throughout the figures.

FIG. 1 is a block diagram of a wireless communication device, according to an exemplary embodiment.

FIG. 2 is a block diagram of a main terminal of the wireless communication device shown in FIG. 1.

FIG. 3 is a block diagram of a subsidiary terminal of the wireless communication device shown in FIG. 1.

### DETAILED DESCRIPTION

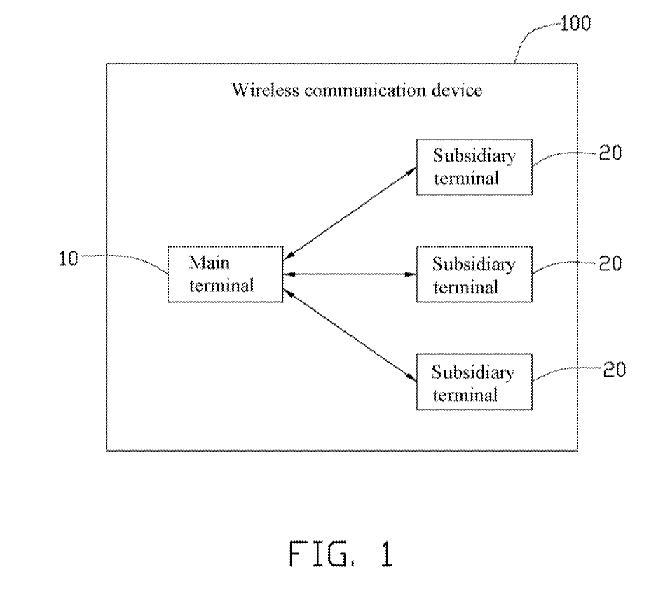

FIG. 1 shows a wireless communication device 100, according to an exemplary embodiment. The wireless communication device 100 includes a main terminal 10 and at least one subsidiary terminal 20. The main terminal 10 can communicate with other wireless communication devices through conventional wireless communication systems, such as Global System for Mobile communication (GSM), Code Division Multiple Access (CDMA), etc. The subsidiary terminal 20 can be carried and operated as conventional wireless communication devices, such as mobile phones, personal digital assistants (PDA) and laptop computers. The subsidiary terminal 20 can also have other functions, such as capturing image and playing games. When the distance between the main terminal 10 and the subsidiary terminal 20 is less than a predetermined distance, the main terminal 10 can also communicate with the subsidiary terminal 20 using short distance wireless communication signals, such as Near Field Communication (NFC) signals, bluetooth signals, Wireless Fidelity (Wi-Fi) signals, Ultra-Wideband (UWB) signals, etc. Thus, the main terminal 10 can be controlled to wirelessly communicate with other wireless communication devices using the subsidiary terminal 20.

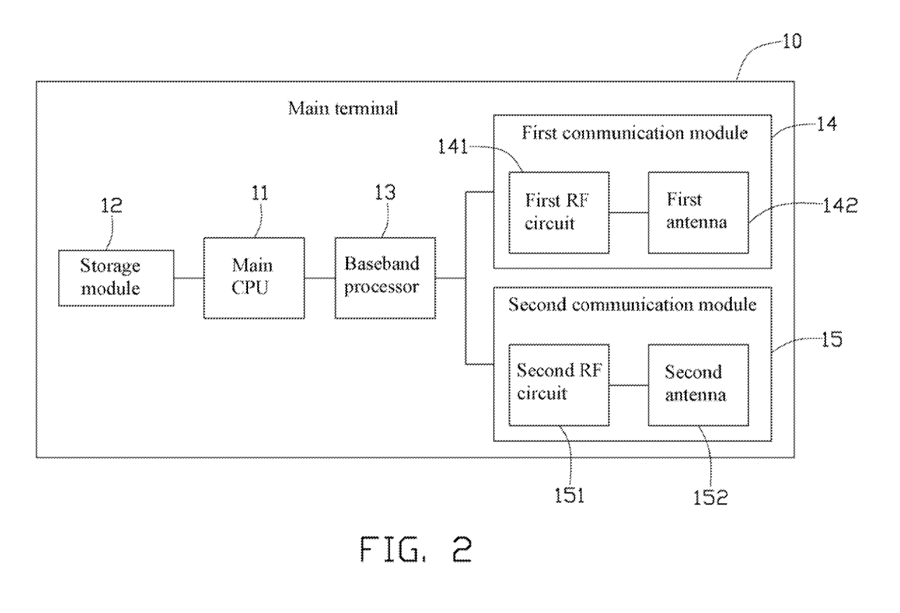

Also referring to FIG. 2, the main terminal 10 includes a main central processing unit (CPU) 11, a storage module 12, a baseband processor 13, a first communication module 14, and a second communication module 15. The storage module 12 and the baseband processor 13 are both electrically connected to the main CPU 11. The first communication module 14 and the second communication module 15 are both electrically connected to the baseband processor 13.

The main CPU 11 can be a conventional CPU of mobile phones or laptop computers. The storage module 12 stores applications and relevant data of the wireless communication device 100. The first communication module 14 includes a first radio frequency (RF) circuit 141 connected to the baseband processor 13 and a first antenna 142 connected to the first RF circuit 141. The first antenna 142 can receive/send wireless signals used in conventional wireless communication systems, such as GSM, CDMA, etc., such that the main terminal 10 communicates with other wireless communication devices through the wireless communication systems. The second communication module 15 includes a second RF circuit 151 connected to the baseband processor 13 and a second antenna 152 connected to the second RF circuit 151. The second antenna 152 can receive/send wireless signals used in short distance wireless communication systems, such as NFC, bluetooth, Wi-Fi, UWB, etc.

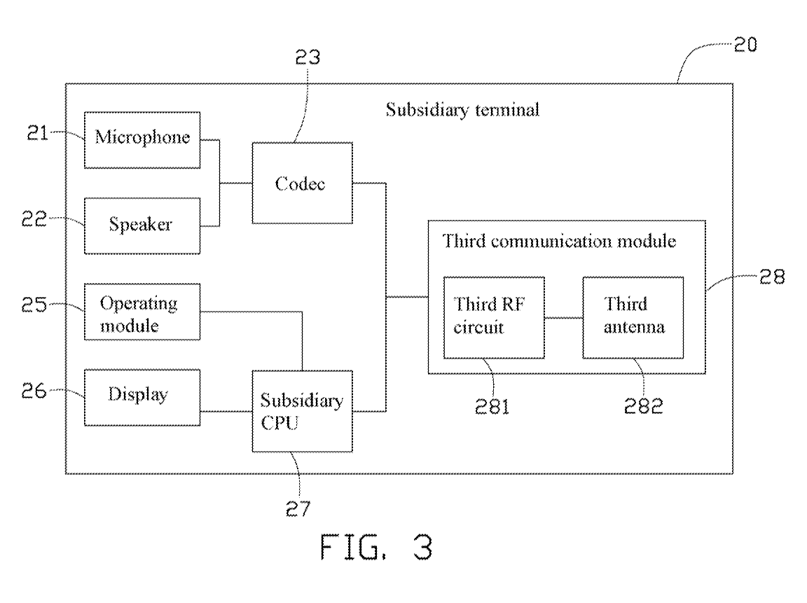

Also referring to FIG. 3, each subsidiary terminal 20 includes a microphone 21, a speaker 22, a codec 23, an operating module 25, a display 26, a subsidiary CPU 27, and a third communication module 28. The microphone 21 and the speaker 22 are both electrically connected to the codec 23. The operating module 25 can be a keypad, a touch pad, etc. The display 26 is electrically connected to the operating module 25. The codec 23, the operating module 25, and the third communication module 28 are all electrically connected to the subsidiary CPU 27. The third communication module 28 includes a third RF circuit 281 connected to the subsidiary CPU 27 and a third antenna 282 connected to the third RF circuit 281. The third antenna 282 can receive/send wireless signals used in short distance wireless communication systems, such as NFC, bluetooth, Wi-Fi, UWB, etc. When the distance between the main terminal 10 and the subsidiary terminal 20 is less than a predetermined distance, the second antenna 152 and the third antenna 282 can send wireless signals to each other and receive wireless signals from each other.

In use, the subsidiary terminal 20 is carried by the user, the distance between the main terminal 10 and the subsidiary terminal 20 should be less than the predetermined distance. Thus, the subsidiary terminal 20 can be used as conventional portable wireless communication terminals, such as mobile phones or laptop computers. When the subsidiary terminal 20 is used to call other conventional wireless communication devices (e.g., mobile phones or laptop computers) or send messages to them, audio signals are input into the subsidiary terminal 20 by the microphone 21, and the operating module 25 and the display 26 can be used to operate the subsidiary terminal 20 to edit messages or input other instruction into the subsidiary terminal 20. The audio signals received by the microphone 21 are transformed into electronic signals by the codec 23, and the electronic signals are transmitted into the subsidiary CPU 27. The operating actions on the operating module 25 generate electronic signals corresponding to messages or other instruction, and the electronic signals are transmitted into the subsidiary CPU 27. The subsidiary CPU 27 controls the third communication module 28 to transform the electronic signals corresponding to the audio signals and/or the operating actions into wireless signals and send the wireless signals to the main terminal 10 by the third antenna 282.

When the second antenna 152 receives the wireless signals sent by the subsidiary terminal 20, the second RF circuit 151 and the baseband processor 13 transform the wireless signals into electronic signals corresponding to the original audio signals and/or operating actions. The electronic signals are then transmitted to the main CPU 12. The main CPU 12 controls the baseband processor 13 and the first communication module 14 to transform the electronic signals corresponding to the audio signals and/or operating actions into wireless signals and send the wireless signals to other conventional wireless communication devices (e.g., mobile phones or laptop computers) by the first antenna 141.

When other conventional wireless communication devices call the wireless communication device 100 or send messages to it, wireless signals are received by the first antenna 142. The main CPU 11 controls the first communication module 14, the baseband processor 13, and the second communication module 15 to process the wireless signals and send the wireless signals to the subsidiary terminal 20 by the second communication module 15. The wireless signals are received and transformed into audio signals and/or messages by the third communication module 28, the codec 23, and/or the subsidiary CPU 27. The audio signals are played by the speaker 22, and the messages are displayed by the display 26.

As above-detailed, the wireless communication device 100 can communicate with other conventional wireless communication devices. Furthermore, when the first communication module 14 receives wireless signals from other communication devices, the main terminal 10 can also first process the wireless signals using the first RF circuit 141, the baseband processor 13, and the main CPU 11 to transform the received wireless signals into files, and store the files in the storage module 12. The stored files can be sent to the subsidiary terminal 20 or other conventional wireless communication devices at predetermined times.

The wireless communication device 100 can includes a plurality of subsidiary terminals 20 that share the main terminal 10 and work according to the above-detailed working method. The subsidiary terminals 20 can also communicate with each other through the main terminal 10. Additionally, the subsidiary terminals 20 can also be used to send instruction to the main terminal 10 using the operating module 25, the display 26, the subsidiary CPU 27 and the third communication module 28, thereby controlling the main terminal 10 to perform desired functions.

In the present exemplary disclosure, the storage module 12 for storing relevant data and the first communication module 14 for communicating with other wireless communication devices are installed in the main terminal 10. The microphone 21, the speaker 22, the codec 23 (i.e., configured for calling), the operating module 25, and the display 26 (i.e., configured for operating the wireless communication device 100) are all installed in the subsidiary terminal 20. Neither the main terminal 10 nor the subsidiary terminal 20 needs all hardware of conventional wireless communication devices installed therein. Thus, the subsidiary terminal 20 can be used as conventional portable wireless communication terminals, such as mobile phones or laptop computers, and have less hardware than the conventional portable wireless communication terminals. Therefore, the subsidiary terminal 20 has more space to install additional hardware, such as digital camera modules or game modules. In this way, the subsidiary terminal 20 can be used as conventional multifunctional wireless communication devices, and it does not adversely influence the miniaturization of the subsidiary terminal 20. Compared with the conventional multifunctional wireless communication devices, the subsidiary terminal 20 has more simplified structure and/or smaller size.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A wireless communication device, comprising:
a main terminal for communicating with other conventional wireless communication devices through wireless communication systems; and
at least one subsidiary terminal communicating with the main terminal using short distance wireless communication signals; wherein audio signals, messages and instruction input into the subsidiary terminal are sent to the main terminal by the subsidiary terminal and then sent to other wireless communication devices by the main terminal; and wireless signals corresponding to audio signals and/or messages received from other wireless communication devices by the main terminal are sent to the subsidiary terminal to be played and/or displayed.

2. The wireless communication device as claimed in claim 1, wherein the main terminal includes a main central processing unit (CPU), a first communication module, and a second communication module; the first communication module and the second communication module both connected to the main CPU, the first communication module communicating with other conventional wireless communication devices, and the second communication module communicating with the at least one subsidiary terminal.

3. The wireless communication device as claimed in claim 2, wherein the main terminal further includes a storage module connected to the main CPU.

4. The wireless communication device as claimed in claim 2, wherein the main terminal further includes a baseband processor, the first communication module and the second communication module connected to the main CPU through the baseband processor.

5. The wireless communication device as claimed in claim 4, wherein the first communication module includes a first radio frequency (RF) circuit connected to the baseband processor and a first antenna connected to the first RF circuit, the first antenna receiving/sending wireless signals used in conventional wireless communication systems.

6. The wireless communication device as claimed in claim 4, wherein the second communication module includes a second RF circuit connected to the baseband processor and a second antenna connected to the first RF circuit, the second antenna receiving/sending wireless signals used in short distance wireless communication systems.

7. The wireless communication device as claimed in claim 2, wherein the subsidiary terminal includes a microphone, a speaker, a codec, and a third communication module; the microphone and the speaker both connected to the codec, the codec connected to the third communication module, and the third communication module communicating with the second communication module using short distance wireless communication signals.

8. The wireless communication device as claimed in claim 7, wherein the subsidiary terminal further includes a subsidiary CPU, an operating module, and a display, the operating module and the display both connected to the subsidiary CPU, and the CPU connected to the third communication module.

9. The wireless communication device as claimed in claim 8, wherein the third communication module includes a third RF circuit and a third antenna, the third RF circuit connected to the codec and the subsidiary CPU, the third antenna connected to the third RF circuit and receiving/sending wireless signals used in short distance wireless communication systems.

10. The wireless communication device as claimed in claim 1, wherein the subsidiary terminal sends instruction to the main terminal, thereby controlling the main terminal to perform desired functions.

11. The wireless communication device as claimed in claim 1, wherein the short distance wireless communication signals are anyone of Near Field Communication (NFC) signals, bluetooth signals, Wireless Fidelity (Wi-Fi) signals, and Ultra-Wideband (UWB) signals.
